(19) United States
(12) Patent Application Publication
(10) Pub. No.: US 2004/0197617 A1
(43) Pub. Date: Oct. 7, 2004

(54) Fuel cell system and burner arrangement for a fuel cell system

(76) Inventors: Andreas Kaupert, Ulm (DE); Gunter Eberspach, Wolfschlugen (DE)

Correspondence Address: M. Robert Kestenbaum, 11011 Bermuda Dunes NE, Albuquerque, NM, 87111, US

(21) Appl. No.: 10/818,069

(22) Filed: Apr. 5, 2004

(30) Foreign Application Priority Data
Apr. 3, 2003 (DE) 103 15 255.5

(51) Int. Cl. H01M 8/18; H01M 8/04; H01M 8/12

(52) U.S. Cl. 429/19; 429/26; 429/20

(57) ABSTRACT

A fuel cell system includes a gas production system for producing a hydrogen-containing gas mixture, a fuel cell to which the hydrogen-containing gas mixture can be supplied for use of the hydrogen contained therein for producing electricity, wherein a hydrogen-depleted gas mixture leaves the fuel cell, a catalytic burner, to which the hydrogen-depleted gas mixture can be supplied for heat production, a heat exchanger arrangement for transferring heat produced in the catalytic burner to a heat carrier medium, a fuel-operated burner following the catalytic burner, and a heat exchanger arrangement for transferring heat produced in the fuel-operated burner to a heat carrier medium.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### FIELD OF THE INVENTION

The present invention relates to a fuel cell system and to a burner arrangement for such a fuel cell system. Fuel cell systems are used to provide electrical energy, for example in motor vehicles. This electrical energy can be used, for example, for operating a drive assembly, but can also be used to supply with energy various other system regions of a motor vehicle which can be electrically operated. A problem with such fuel cell systems is that they have to be brought to suitable operating temperatures, which are markedly above the generally prevailing ambient temperatures, before being brought into operation.

### SUMMARY OF THE INVENTION

The present invention has as its object to provide a fuel cell system and a burner arrangement for a fuel cell system, by means of which the different system regions required to be brought into operation can be reliably heated with a constructionally simple configuration.

This object is attained according to the invention by a fuel cell system comprising a gas generation system for producing a hydrogen-containing gas mixture, a fuel cell to which the hydrogen-containing gas mixture can be supplied for the use of the hydrogen contained therein for the production of electricity, wherein a hydrogen-depleted gas mixture leaves the fuel cell, a catalytic burner to which the hydrogen-depleted gas mixture can be supplied for heat production, a heat exchanger arrangement for transferring heat production in the catalytic burner to a heat carrier medium, a fuel-operated burner following the catalytic burner, and a heat exchanger arrangement for transferring heat produced in the fuel-operated burner to a heat carrier medium.

In addition to the catalytic burners generally present in fuel cell systems, and in which the residual hydrogen which can still be contained in the gas mixture leaving a fuel cell can be combusted and thus heat can be provided, in order to heat other system regions in a vehicle, which catalytic burners however cannot yet be used in order to preheat the fuel cell system, as long as this is not yet in operation, according to the invention a further burner is provided which can provide the preheating required for starting the fuel cell system. This additional fuel-operated burner, which can be operated with diesel fuel or other fossil or hydrocarbon-containing fuels, can however be used, not only for heating the fuel cell system per se, but can also be used as an auxiliary or a stationary heater.

In order to be able to further simplify the construction of the system according to the invention by merging functions or assemblies, the catalytic burner has a fan, by means of which air can be forwarded for reaction in the catalytic burner and/or reaction in the fuel-operated burner. Thus a common fan is provided for the catalytic burner and for the fuel-operated burner, so that the air forwarded by this fan can flow first through the catalytic burner and then through the fuel-operated burner. According to which of these two burners is then operated at the time, the air forwarded by the fan into the one or other burner is reacted for heat production. For further merging of functions, it can preferably be provided that air can be forwarded by the fan to the fuel cell.

In order to be able to use as efficiently as possible the heat respectively produced in the catalytic burner on the one hand, and in the fuel-operated burner on the other hand, by the course of a chemical reaction (catalytic reaction or combustion), it is proposed that a first heat exchanger arrangement is provided in the flow direction between the catalytic burner and the fuel-operated burner for transferring heat produced in the catalytic burner to a first heat carrier medium, and that downstream of the fuel-operated burner a second heat exchanger arrangement is provided for transferring heat produced in the fuel-operated burner to a second heat transfer medium.

A very effective heating of the gas production system can be achieved in that the heat carrier medium and/or the combustion products of the fuel-operated burner and/or of the catalytic burner can be supplied to the gas production system and/or the fuel cell for heating. Furthermore it is basically possible that the heat carrier medium and/or the combustion products of the fuel-operated burner and/or of the catalytic burner can be supplied to the gas production system as reaction material for production of the hydrogen-containing gas mixture.

Particularly at comparatively low ambient temperatures, in order to obtain an even more accelerated preheating of the fuel cell system, and in particular of the gas generating system thereof, a further fuel-operated burner is allocated to the gas production system for producing a stream of heated gas for feeding into a heat exchanger arrangement of the gas production system and/or for feeding into a reformer of the gas production system. In order to be able to further improve the heating efficiency with this system, water can be mixed into the stream of heated gas. By the addition of water to the heated gas stream prepared by this further fuel-operated burner, a heated medium is prepared which, because it contains water or water vapor, has a markedly increased heat storage capacity and thus contributes to a markedly increased heat transfer to, for example, the gas production system.

According to a further aspect of the present invention, a fuel cell system, comprises a gas production system for the production of a gas stream substantially containing hydrogen and a hydrogen-depleted gas stream; a fuel cell to which the substantially hydrogen-containing gas stream can be supplied for the use of hydrogen for producing electricity; a catalytic burner, to which the hydrogen-depleted gas stream can be supplied for heat production; a heat exchanger arrangement for transferring heat produced in the catalytic burner to a heat carrier medium; a fuel-operated burner following the catalytic burner; and a heat exchanger arrangement for transferring heat produced in the fuel-operated burner to a heat carrier medium.

A hydrogen-containing gas mixture is thus first produced in this fuel cell system. Before being fed into the fuel cell, it is divided into two gas streams. One of the gas streams is highly enriched with hydrogen, i.e., substantially comprises hydrogen with a small proportion of impurities. The other gas stream is then a hydrogen-depleted gas stream, containing however only a given residual proportion of hydrogen and not used in the fuel cell, but now conducted directly to the catalytic burner, to be converted there for heat production.

According to a further aspect of the present invention, the previously stated object is attained by a burner arrangement, particularly for a fuel cell system according to one of the foregoing claims, comprising an upstream first supply region for the supply of air by means of an air forwarding fan and/or for the supply of a hydrogen-containing gas mixture; a first burner region with a catalyst arrangement for reacting the hydrogen-containing gas mixture for heat production; a second burner region downstream of the first burner region, with a second supply region for supplying fuel for forming an ignitable fuel-air mixture together with air supplied in the first supply region; and also a heat exchanger arrangement downstream of the second burner region, for transferring heat produced in the first burner region and/or in the second burner region to a heat carrier medium.

According to this aspect of the invention, two burner regions are thus provided one after the other in a flow direction, leading to the special advantage that a common air forwarding fan can be used to supply air to these two burner regions, respectively for heat production.

In order to avoid damage in the region of the catalyst material of the first burner region due to flashbacks or due to excessive temperatures in the heat exchanger arrangement following the second burner, it is furthermore proposed that a flame barrier is arranged between the first burner region and the second burner region and/or the second burner region and the heat exchanger arrangement.

Furthermore, to increase heat transfer efficiency, it can be provided that a further heat exchanger arrangement is provided between the first burner region and the second burner region, for transferring heat produced in the first burner region to a heat transfer medium.

In order to be able to ensure efficient operation, particularly in the second burner region, it is proposed that the second burner region has a combustion chamber in which the air forwarded by the air forwarding fan and fuel vapor produced in a fuel evaporator can be brought to ignition using an ignition member. Here it is for example possible that the fuel evaporator has a porous vaporizer medium receiving a liquid fuel and, allocated to this, a heating device for fuel vapor production. The fuel-operated burner thus works according to the principle of a so-called evaporative burner.

In a preferred constructional embodiment, it can further be provided that the fuel evaporator has an evaporator housing which is open in a downstream direction, into which fuel to be vaporized can be introduced, and around which the air forwarded by the air forwarding fan can flow for mixing with fuel vapor downstream of the evaporator housing.

### BRIEF DESCRIPTION OF THE FIGURES

The present invention is described in detail hereinafter with reference to the accompanying drawings.

FIG. 1 is a block type diagram of a fuel cell system according to a first embodiment;

FIG. 2 is a diagram of the principle of a burner arrangement which can be used with the system of FIG. 1;

FIG. 3 is a view corresponding to FIG. 1 of an alternatively constructed system;

FIG. 4 is a block type diagram of a fuel cell system of a further embodiment;

FIG. 5 is a further block type diagram of a fuel cell system according to a further embodiment.

### DETAILED DESCRIPTION OF THE INVENTION

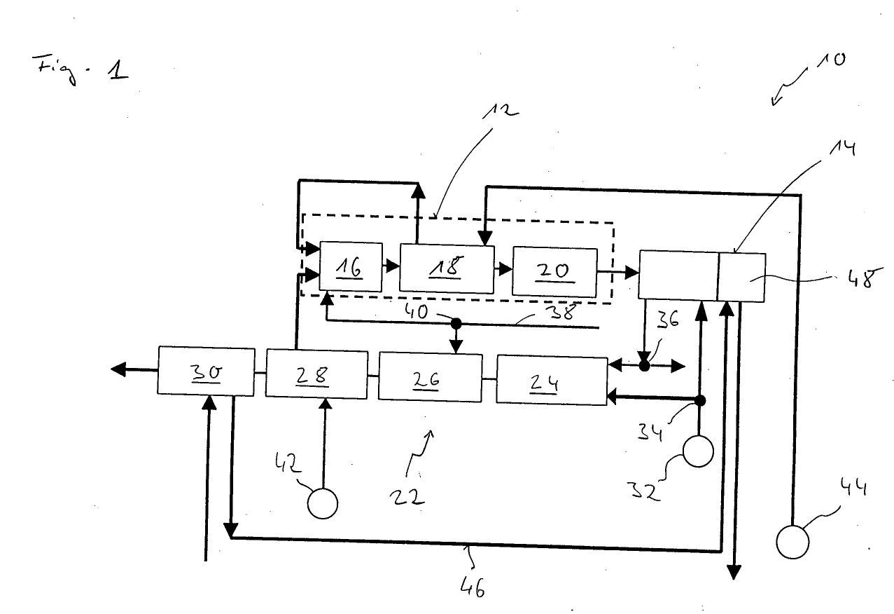

A system according to the invention is denoted by 10 in FIG. 1. This fuel cell system 10 according to the invention includes as essential system regions, firstly a gas production system 12 delimited by a dashed line, for producing a hydrogen-containing gas mixture, and secondly a fuel cell 14 which receives this hydrogen-containing gas mixture. The gas production system 12 itself includes as essential components a reformer 16, in which air, water, and hydrogen-containing fuel are converted into a hydrogen-containing gas mixture, following this a heat exchanger arrangement 18, in which the reformate produced in the reformer 16 is cooled, and also a gas purification stage 20, in which the hydrogen-containing gas mixture is purified from constituents which could impede the operation of the fuel cell 14 or possibly damage it.

The fuel cell system according to the invention furthermore includes a burner arrangement, generally denoted by 22. This burner arrangement 22, as shown in FIG. 1, has in succession in the flow direction a catalytic burner 24, a fuel-operated burner 26, a first heat exchanger arrangement 28, and a second heat exchanger arrangement 30. Allocated to the catalytic burner 24, an air forwarding fan 32 is provided, which can forward air via a changeover valve 34 either into the catalytic burner 24 or into the fuel cell 14, or possibly, with a corresponding division ratio, both into the catalytic burner 24 and also into the fuel cell 14. Furthermore, the gas mixture leaving the fuel cell 14 is likewise supplied, via a selective changeover valve 36, to the catalytic burner 24; the said gas mixture always still contains hydrogen when the fuel cell is operating, but in a smaller proportion than in the gas mixture stream which is introduced from the gas production system 12 into the fuel cell 14. The stream leaving the fuel cell 14 can however be selectively discharged into the environment by means of the valve 36.

Via a fuel supply duct 38, by means of a selective changeover valve 40, fuel, i.e. for example diesel fuel, gasoline or other liquid fossil fuel, is selectively introduced into the fuel-operated burner 26, the reformer 16, or both these system regions. Furthermore, air as a heat carrier medium is conducted by means of a compressor 42 through the first heat exchanger arrangement 28 to the reformer 16. Water is conducted to the gas production system 12 by a further compressor or a pump 44, and in fact such that it is first introduced into the heat exchanger arrangement 18 of the gas production system 12, and after flowing through this heat exchanger arrangement 18 is introduced into the reformer 16. When fuel is introduced via the fuel supply duct 38, air via the heat exchanger arrangement 28, and water via the heat exchanger arrangement 18, a hydrogen-containing gas mixture can then be produced in the reformer 16. Water circulates in a heat carrier medium circuit generally denoted by 46, and flows both through the second heat exchanger arrangement 30 of the burner arrangement 22 and also a heat exchanger arrangement 48 of the fuel cell 14, in order to take up or give up heat.

The operation of the fuel cell system shown in FIG. 1 is described hereinafter. It is first assumed that the whole system 10 is in a cold state, and thus a state in which the various catalytically induced reactions in the reformer 16, in the fuel cell 14, and in the catalytic burner 24 cannot yet proceed. The fuel-operated burner 26 is therefore first activated, in fact by corresponding changing the valve 40 to feed fuel into it, and furthermore by corresponding changeover of the valve 34, the air forwarded by the fan 32 is introduced through the catalytic burner 24 and likewise into the fuel-operated burner 26. An ignitable mixture of fuel vapor and combustion air is then produced in this, and is brought to combustion. The combustion gases flow through the two heat exchanger arrangements 28 and 30. In the heat exchanger arrangement 28, heat is transferred to the gas producing system 12 or to its reformer 16, so that now heated air can flow through the gas producing system 12 and the fuel cell 14. This heated air leaves the fuel cell 14 via the valve 36 and can now either be discharged to the environment or forwarded again as combustion air to the fuel-operated burner 26 via the catalytic burner 24. In this case, operation of the fan 32 can be omitted during the starting phase, when the air stream provided by the compressor 42 is set such that it leads, with corresponding fuel supply, to a suitable, ignitable fuel/air mixture. It is otherwise basically possible to operate only the fan 32, or with a corresponding air requirement, both the fan 32 and also the compressor 42.

Furthermore, the combustion exhaust gases leaving the fuel-operated burner 26 heat the water circulating in the direction of the arrows in the circuit 46 in this phase in the second heat exchanger arrangement 30. This water likewise contributes in the heat exchanger arrangement 48 to the heating of the fuel cell, as does the heated air which enters the fuel cell 14 after flowing through the heat exchanger arrangement 28 and the gas producing system 12.

If sufficiently high temperatures are reached in the various system regions, for gas production on the one hand and for activation of the fuel cell 14 on the other hand, the fuel cell 14 is set in operation. For this, it is further required that now fuel delivered via the duct 38 is introduced into the reformer 16 via the valve 40. Using the air preheated in the heat exchanger arrangement 28, the water possibly likewise preheated in the heat exchanger arrangement 18, and the supplied fuel, as already mentioned above, a hydrogen-containing gas is then produced in the reformer 16, is further cooled in the heat exchanger arrangement 18, and then transfers heat to the water to be introduced into the reformer 16.

Electricity is now produced with the reaction occurring in the fuel cell 14, and the gas mixture leaving the fuel cell 14 is a gas mixture depleted in hydrogen but not free from hydrogen. This gas mixture is now, according to need, introduced into the catalytic burner 24. Furthermore air is now introduced into the catalytic burner 24 under the forwarding effect of the fan 32, the valve 34 being changed over so that a portion of the air also reaches the fuel cell 14, to be reacted there, together with the hydrogen-rich gas mixture likewise introduced into this, for current generation. The air introduced into the catalytic burner 24 and the hydrogen-depleted gas mixture likewise introduced into this are reacted by performing a catalytic reaction with heat production, with water or water vapor being produced in this conversion reaction. The heat-transporting reaction products which are produced in the catalytic burner 24 flow through the now deactivated fuel-operated burner 26 and thus reach the heat exchanger arrangement 28 or the heat exchanger arrangement 30. A large portion of the heat transported by the reaction products is transferred in the heat exchanger arrangement 28 to the air forwarded through this by the compressor 42 and to be introduced into the reformer 16, so that this also, on entering the reformer 16 now working for hydrogen production, already has a suitably elevated temperature. Since furthermore in operation of the fuel cell this must no longer be heated, but according to the fuel cell type must be more or less strongly cooled, heat is now transferred via the circuit 46 to the water circulating therein in the heat exchanger arrangement 48; for this, for example, the direction of circulation can be the reverse of the direction of circulation shown. It should furthermore be mentioned that in this circuit 46, of course, a pump forwarding the water can be provided, as can a further heat exchanger arrangement, not shown, in which then heat which the water circulating in the circuit 46 has taken up, either in the heat exchanger arrangement 30 or in the heat exchanger arrangement 48, can be transferred to the air to be introduced for heating the vehicle interior.

The fuel cell system previously described with reference to FIG. 1 thus uses, very efficiently particularly in the region of the burner arrangement 22, an otherwise existing or required air stream, which is provided by the fan 32. Thus a merging of system regions is present, which simplifies the structure and results in an efficiently operating overall system.

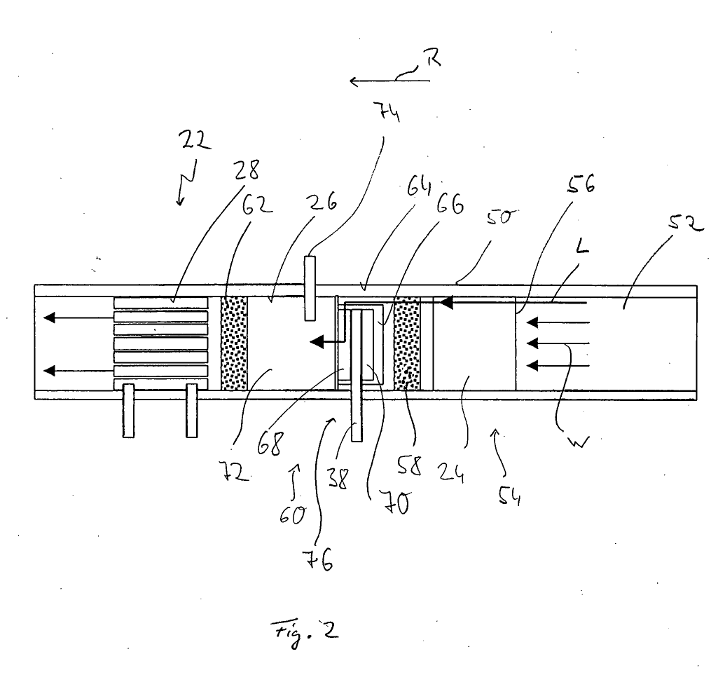

Such a burner arrangement 22, as can be used in the system shown in FIG. 1, can be recognized in a principle illustration in FIG. 2. This burner arrangement 22 includes a tubular housing 50, to which air L is supplied in an upstream first supply region 52 by the fan 32 or the compressor 42. Furthermore, in this upstream supply region 52, as indicated by the arrows W, the hydrogen-depleted gas is supplied from the fuel cell 14. A catalyst material 56 is provided in a first burner region 54 following in the flow direction R and substantially forming the catalytic burner 24. This first burner region 54 is followed, in the flow direction R and after a flame barrier 58, by a second burner region 60, which is substantially produced by the previously already mentioned fuel-operated burner 26. This fuel-operated burner 26 is then followed by a second flame barrier 62 and also the heat exchanger arrangement 28. The second heat exchanger arrangement 30 likewise shown in FIG. 1 cannot be seen in FIG. 2, but can however in a corresponding manner of course have a volume region through which the medium to be heated can flow.

The fuel-operated burner 26 includes a fuel evaporator 64 following after the first flame barrier 58. This has a pot-shaped evaporator housing 66, closed upstream and open downstream. A porous evaporator medium 68 and possibly allocated to this, an electrically operated heating device 70, are arranged in this evaporator housing 66. Fuel is introduced into the porous evaporator medium 68 through the previously already mentioned duct 38. When the electrically operable heating device 70 is excited, fuel present in the porous evaporator medium is evaporated. Gases flowing through the first burner region 54, in particular also the air L, can flow around the evaporator housing 66 at its upstream and its peripheral region. This air L mixes in the downstream open region of the evaporator 64 with the fuel vaporized therein, and thus produces an ignitable mixture of fuel, vapor, and air, which can be ignited in a combustion chamber 72 of the fuel-operated burner 26 by a glow ignition member 74 for combustion. It should be mentioned here that of course care can be taken in the region of the evaporator 66 that the air to be combusted with the vaporized fuel also enters the porous medium 68 and thus leads to increased vaporization.

According to which of the two burner regions 54, 60 is operated, the combustion products transporting heat reach the heat exchanger arrangement 28 or the heat exchanger arrangement 30, in order to transfer the heat there to the heat carrier medium, thus water or air, flowing through these.

In the burner arrangement 22 shown in FIG. 2 there can be seen as an elementary principle the positioning of the two burner regions 54, 60 in succession in the flow direction R and provided with a common air supply. In the upstream first supply region 52 the hydrogen-containing gas mixture W is furthermore supplied, required for the operation of the first burner region 54, while the fuel required for the operation of the burner region 60 is supplied in a second or downstream supply region 76 substantially provided by the duct 38.

The two flame barriers 58, 62 provided between the burner regions 54, 60 and between the burner region 60 and the first heat exchanger arrangement 28 make sure that on the one hand damage to the catalytic material 56 due to back-ignition can be prevented, and on the other hand the flames from the combustion chamber 72 cannot directly reach the region of the heat exchanger arrangement 28 and of the evaporator housing 66 and cannot locally contribute there to excessive heating.

It is evident that in principle the two burner regions 54, 60 can be operated simultaneously if sufficient air is supplied, so that all the oxygen contained in this air is not already brought to reaction in the burner region 54. It can likewise be recognized from the previously described functional principle of the fuel cell system 10 shown in FIG. 1 that basically the simultaneous operation of the catalytic burner 24 and of the fuel-operated burner 26 is not required. Simultaneous operation can however be required for exhaust gas after-treatment.

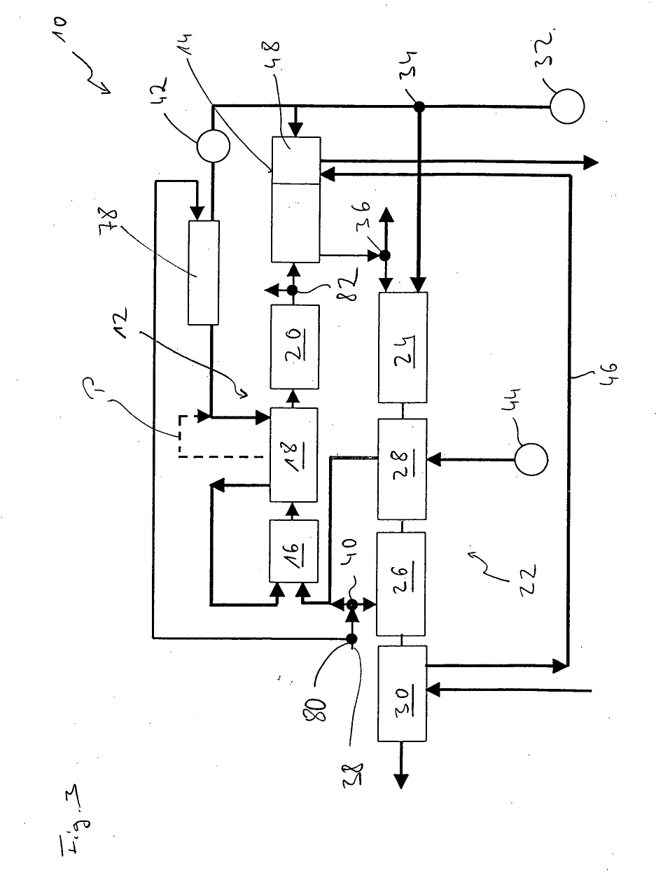

A modified fuel cell system 10 is shown in FIG. 3. It can first be seen that the sequence of the fuel-operated burner 26 and the first heat exchanger arrangement 28 has been interchanged in the burner arrangement 22. The first heat exchanger arrangement 28 now immediately follows the catalytic burner 24 and transfers the heat produced there to the water forwarded by means of the pump 44 to the reformer 16 of the gas production system 12. The air required for hydrogen production is first conducted by the forwarding effect of the fan 32 and via the valve 34 in the direction of the catalytic burner 24, or respectively to the fuel cell 14 and also in the direction of the compressor 42, which now provides the pressure required to feed the air into the gas producing system 12. A further fuel-operated burner 78 is arranged after the compressor 42. The additional fuel-operated burner which can be seen in the embodiment according to FIG. 3 can be of conventional construction and work as an evaporating burner, as likewise the fuel operated burner 26 which can be seen. The air forwarded by the compressor 42 flows through the fuel-operated burner 78, as long as this is not activated, enters the heat exchanger arrangement 18 of the gas producing system 12, and leaves this heat exchanger arrangement 18 again, in order to then be conducted to the reformer 16. The fuel brought in via the duct 38 is now conducted via the valve 44 and a further valve 80 to the fuel-operated burner 26, to the fuel-operated burner 78 and to the reformer 16; according to each changeover of the valves 40, 80, here selectively only one, or plural, of these regions can be supplied with liquid fuel.

This fuel cell system shown in FIG. 3 is operated such that firstly again the fuel-operated burner 26 and additionally also the fuel-operated burner 78 are activated. For this, at least the fan 32 also allocated to the catalytic burner 24, however preferably additionally also the compressor 42, are activated. The heat produced in the fuel-operated burner 26 is now transmitted in the heat exchanger arrangement 30 to the water circulating in the circuit 46 and from this to the heat exchange arrangement 48 of the fuel cell 14. The heat produced in the fuel-operated burner 78 is now transported in the combustion products thereof to the heat exchanger arrangement 18. These combustion products are then cooled, with simultaneous heating of the heat exchanger arrangement 18, and then enter the reformer 16. Heat is also given up in the reformer 16, so that these combustion products now enter the heat exchanger arrangement 18 with a temperature lower than that temperature which the combustion products had on leaving the fuel-operated burner 78 and on first entering the heat exchanger arrangement 18. This leads to the combustion products conducted further to the gas purification stage 20 being somewhat heated again. This leads to a very uniform distribution of the heat to the various system regions of the gas production system 12 and also of the fuel cell 14.

A further valve 82 is however now connected before the fuel cell 14. By means of this valve it is possible selectively to conduct the gas leaving the gas production system 12 to the fuel cell 14 or to discharge it externally. In the starting phase of the system, in which in particular in the fuel-operated burner 78 a very high proportion of carbon monoxide is produced, this valve 82 is changed over so that after flowing through the gas production system 12 these combustion products cannot reach the fuel cell 14, since they can lead to damage to the catalyst material there. Only when these combustion products have a smaller CO content can they also be conducted through the fuel cell 14 by correspondingly changing over the valve 82 and thereby also additionally to contribute to its heating, or if necessary, with corresponding changing of the valve 36, also be introduced into the catalytic burner 24 to heat it or the catalyst material. However, since hereby possibly an impairment of the operation of the fuel-operated burner 26 can be produced, basically the combustion product of the fuel-operated burner 78 leaving the fuel cell 14 can be discharged externally via a valve 36 or be discharged into an exhaust gas purification system.

As indicated by a dashed arrow P, it is possible to additionally mix a given proportion of water into the combustion products leaving the fuel-operated burner 78. Due to the high temperature of these combustion products, this water is evaporated and is transported as water vapor through the heat exchanger arrangement 18 and the reformer 16. In this manner, for example, about a third of the total water fed into the reformer 16 is used beforehand for an increased heating of the heat exchanger arrangement 18 because of the higher heat capacity of the combustion products enriched with water vapor.

If the required temperatures are attained in the system shown in FIG. 3, the two fuel-operated burner arrangements 26, 78 are deactivated, and in the catalytic burner 24, with the fuel cell 14 simultaneously operated, the reaction can proceed with conversion of hydrogen and air oxygen, whose heat of reaction is then transferred in the heat exchanger arrangement 28 to the water conducted to the reformer 16.

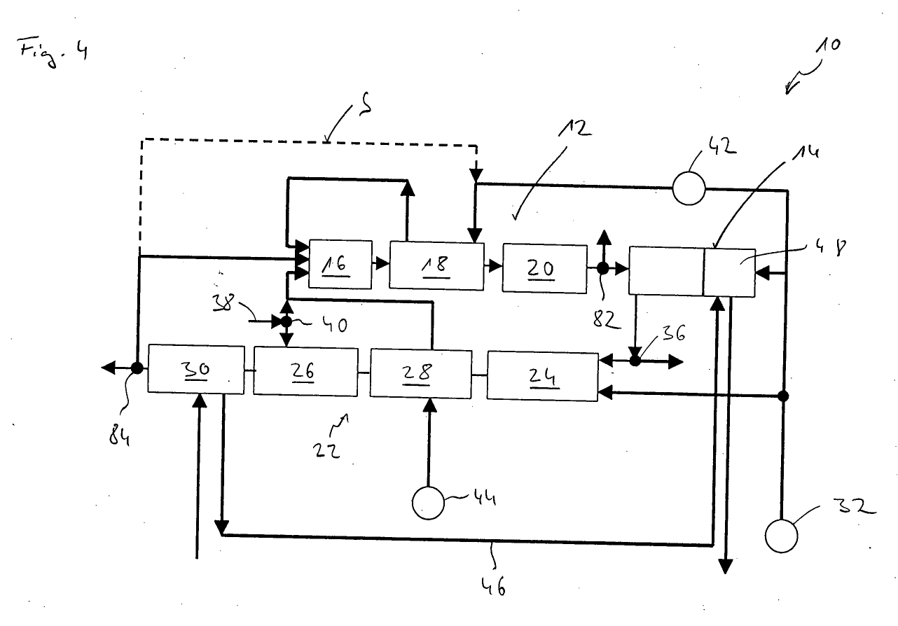

A further embodiment of a fuel cell system according to the invention is shown in FIG. 4. This is essentially constructed like the fuel cell system previously described with reference to FIG. 3. It can however be seen that a changeover valve 84 is now provided in the exhaust gas stream of the burner arrangement 22 following the second heat exchanger arrangement 30. The combustion products of the fuel-operated burner 26 can be selectively conducted into the reformer 16 of the gas production system 12 by means of this changeover valve 84. Here the fuel-operated burner 26 thus replaces the additional fuel-operated burner 78 which can be seen in FIG. 3 insofar as on the one hand it contributes for heating in the heat exchanger arrangement 30 water circulating in the circuit 46 and heating the fuel cell 14; and in that on the other hand it contributes, with its always still hot combustion exhaust gases, to heating the gas production system 12. Here also, in the starting phase of the fuel-operated burner 26, by corresponding position of the valve 82, the combustion products flowing through the fuel production system 12 are not conducted to the fuel cell. Only when the CO content has fallen to a value which is not damaging to the fuel cell, the fuel cell 14 can also be preheated by these combustion products, by changing over the valve 82.

Alternatively it is possible here, as indicated by a dashed arrow S, to conduct the combustion products of the fuel-operated burner 26, not directly into the reformer 16, but first into the heat exchanger arrangement 18 of the gas production system 12, so that, just as described hereinabove, this heat exchanger arrangement 18 is also preheated, the combustion products then flow through the reformer 16 while heating it, and then take up heat again in the heat exchanger arrangement 18 from combustion products entering this.

In a modification of the fuel cell system 10 shown in FIG. 4, the valve 84 can be arranged between the fuel-operated burner 26 and the heat exchanger arrangement 30, in order to conduct the combustion exhaust gases of the fuel-operated burner 26, or a portion thereof which can be determined by the position of the valve 84, not through the heat exchanger arrangement 30, but immediately without substantial heat losses to the gas production system 12 for heating the same.

It should be mentioned that all the fuel cell systems 10 described hereinabove have the elementary advantage that because of the incorporation of a fuel-operated burner 26 and/or 78, the whole system additionally, also in connection with the circuit 46, can be operated as an auxiliary heater, for example for a diesel assembly, or as stationary heating for a vehicle interior.

In particular in stationary mode it is further possible, after corresponding heating of the gas purification system 12 and the fuel cell 14, to use the electrical energy then produced when operating the same for supplying the fuel-operated burner 26. During the starting phase, in which the fuel cell 14 does not yet work, an external energy source is necessary for this.

It should further be mentioned that it is possible in all the described systems to design the gas production system 12 such that additional heat is provided by over-stoichiometric combustion of the fuel fed into the reformer 16 in an upstream or downstream region, and contributes to a further accelerated heating, particularly of various system components of the gas production system 12.

In all the fuel cell systems according to the invention, it is of course possible to use other types as the fuel-operated burner/s, instead of the previously described evaporative burner/s. Thus atomizer burners or matrix burners can be used can for example likewise be used.

In a further embodiment, not shown in the Figures, it is furthermore possible to design the gas production system 12 such that it first produces a hydrogen-containing gas mixture, which is then divided into two partial streams having a hydrogen separating membrane. A first of these partial streams substantially contains only hydrogen and is conducted to the fuel cell 14. The second partial stream is hydrogen-depleted, but always still contains a determined proportion of hydrogen. This hydrogen-depleted gas stream is then not conducted to the fuel cell 14, but directly to the catalytic burner 24, in order to be reacted with air there and to produce heat. In such a system it is furthermore possible to conduct the stream leaving the fuel cell 14 and always still containing a proportion of hydrogen, similarly to the hydrogen-depleted gas stream, to the catalytic burner 24, in order to be able to use the still present hydrogen for heat production there.

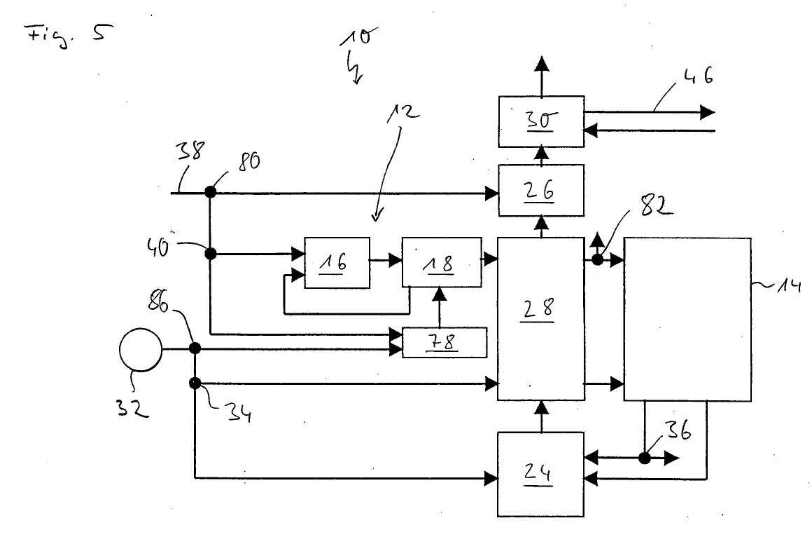

A further embodiment according to the invention of a fuel cell system 10 is shown in FIG. 5. In contrast to the previously described systems, where so-called PEM fuel cells were used which need cooling during operation, a high temperature fuel cell, thus a so-called SOFC fuel cell, is used in the system shown in FIG. 5, working at a temperature of about 650° C. It is therefore not possible with this fuel cell to produce the temperature required for operation with water as heat carrier. In the fuel cell system shown in FIG. 5, the water-conducting circuit is therefore not in contact with the fuel cell 14. Instead, it can be seen that the hydrogen-containing gas mixture leaving the gas production system, without being passed through a gas purification stage, flows through the heat exchanger arrangement 28 and then reaches the fuel cell 14. Furthermore, a fuel-operated burner 78 precedes the gas production system 12, and fuel can be supplied thereto by corresponding setting of the valves 80, 40, and air can be supplied, by corresponding setting of a valve 86, from the fan 32 or a compressor or the like.

In the preheating phase, with the fuel-operated burner 78 operated, hot combustion products are produced by the combustion, flow through the heat exchanger arrangement 18, and are conducted into the reformer 16. When they flow through the reformer16, this is also heated. The combustion products then reach the valve 82 and can also be conducted through the fuel cell 14 for preheating this. Should it be required, it is however also possible to discharge these combustion products via the valve 82 and a gas purification system (not shown) to the surroundings. After sufficient preheating of the gas producing system 12 or respectively the fuel cell 14, with the fuel-operated burner 78 deactivated, the production of the hydrogen-containing gas mixture is started, in order to also operate the fuel cell 14 for current production. As well as the fuel supplied via the valves 80, 40, air is then required in the reformer 16, and is fed into the reformer 16 via the fuel-operated burner 78, which in this phase is however not activated, and the heat exchanger arrangement 18, and thus also simultaneously preheated with the production of the reformate. The hydrogen-depleted gas mixture which leaves the fuel cell 14 is conducted via the valve 36 to the catalytic burner 24 and reacted there with the air supplied via the valves 86, 34 for heat production. In the heat exchanger arrangement 28, this heat is then transferred to the air to be conducted into the fuel cell 14 via the valves 86, 34, in order to preheat this.

In the system shown in FIG. 5, the fuel-operated burner 26 works with the heat exchanger arrangement 30 connected following this solely for heating other vehicle regions, for example, as stationary heating or as an auxiliary heater. An alternative is however also possible in which the positioning of the fuel-operated burner 26 and of the heat exchanger arrangement 28 is interchanged, and for example the staggered arrangement is present which can be seen in FIG. 1. In this case, the fuel-operated burner 26 can also be operated in the starting phase, in order to transfer the heat produced there in the heat exchanger arrangement 28 to air which is then fed into the fuel cell 14 for preheating this.

What is claimed is:

1. Fuel cell system, comprising
a gas production system (12) for producing a hydrogen-containing gas mixture,
a fuel cell (14) to which the hydrogen-containing gas mixture is supplied for using the hydrogen contained therein for producing electricity, wherein a hydrogen-depleted gas mixture leaves the fuel cell (14),
a catalytic burner (24) to which the hydrogen-depleted gas mixture is supplied for producing heat, and a heat exchanger arrangement (28, 30) for transferring heat produced in the catalytic burner (24) to a heat carrier medium,
a fuel-operated burner (26) following the catalytic burner (24),
a heat exchanger arrangement (28, 30) for transferring heat produced in the fuel-operated burner (26) to a heat carrier medium.

2. Fuel cell system according to claim 1, wherein the catalytic burner (24) comprises a fan (32, 42) by means of which air is forwarded for reaction in the catalytic burner (24) or/and for reaction in the fuel-operated burner (26).

3. Fuel cell system according to claim 2, wherein air is forwarded by the fan (32, 42) to the fuel cell (14).

4. Fuel cell system according to claim 1, wherein
a first heat exchanger arrangement (28) is provided in the flow direction (R) between the catalytic burner (24) and the fuel-operated burner (26), for transferring heat produced in the catalytic burner (24) to a first heat carrier medium; and wherein a second heat exchanger arrangement (30) is provided downstream of the fuel-operated burner (26), for transferring heat produced in the fuel-operated burner (26) to a second heat carrier medium.

5. Fuel cell system according to claim 1, wherein
the heat carrier medium and/or the combustion products of the fuel-operated burner (26) and/or of the catalytic burner (24) can be supplied to the gas production system (12) and/or to the fuel cell (14) for heating.

6. Fuel cell system according to claim 1, wherein
the heat carrier medium and/or the combustion products of the fuel-operated burner (26) and/or of the catalytic burner (24) can be supplied to the gas production system (12) as reaction material for producing the hydrogen-containing gas mixture.

7. Fuel cell system according to claim 1, wherein
a further fuel-operated burner (78) is allocated to the gas production system (12) for producing a stream of heated gases for feeding into a heat exchanger arrangement (18) of the gas production system (12) and/or for feeding into a reformer (16) of the gas production system (12).

8. Fuel cell system according to claim 7, wherein
water can be admixed to the stream of heated gases.

9. Fuel cell system, comprising
a gas production system for producing a substantially hydrogen-containing gas stream and a hydrogen-depleted gas stream,
a fuel cell to which the substantially hydrogen-containing gas mixture can be supplied, for using hydrogen for producing electricity,
a catalytic burner to which the hydrogen-depleted gas stream is supplied for producing heat,
a heat exchanger arrangement for transferring heat produced in the catalytic burner to a heat carrier medium,
a fuel-operated burner following the catalytic burner,
a heat exchanger arrangement for transferring heat produced in the fuel-operated burner to a heat carrier medium.

10. Burner arrangement, in particular for a fuel cell system (10) according to claim 1, including:
an upstream first supply region (52) for supplying air (L) by means of an air forwarding fan (32, 42) and/or for supplying a hydrogen-containing gas mixture (W),
a first burner region (54) with a catalyst arrangement (56) for reaction of the hydrogen-containing gas mixture (W) for heat production,
downstream of the first burner region (54), a second burner region (60) with a second supply region (76) for supplying fuel for forming an ignitable fuel/air mixture together with the air (L) supplied in the first supply region (52),
downstream of the second burner region (60), a heat exchanger arrangement (28, 30) for transferring heat produced in the first burner region (54) and/or in the second burner region (60) to a heat carrier medium.

11. Burner arrangement according to claim 10, wherein
a flame barrier (58, 62) is arranged between the first burner region (54) and the second burner region (60) and/or the second burner region (60) and the heat exchanger arrangement (28, 30).

12. Burner arrangement according to claim 10, wherein
a further heat exchanger arrangement (28) is provided between the first burner region (54) and the second burner region (60) for transferring heat produced in the first burner region (54) to a heat carrier medium.

13. Burner arrangement according to claim 10, wherein
the second burner region (60) has a combustion chamber (72) in which the air forwarded by the air forwarding fan (32, 42) and fuel vapor produced in a fuel evaporator (64) can be brought to combustion using an ignition member (74).

14. Burner arrangement according to claim 13, wherein
the fuel evaporator (64) has a porous evaporator medium (68) taking up liquid fuel and allocated to this a heating device (78) for producing fuel vapor.

15. Burner arrangement according to claim 13, wherein
the fuel evaporator (64) has an evaporator housing (66), open in the downstream direction, into which fuel to be evaporated can be introduced, and around which air, forwarded in by the air forwarding fan (32, 42), can flow for mixing with fuel vapor downstream of the evaporator housing (66).
